(19) United States
(12) Patent Application Publication
(10) Pub. No.: US 2009/0218454 A1
(43) Pub. Date: Sep. 3, 2009

(54) Case for a Portable Electronic Device

(76) Inventor: Brian Wayne Stanley, Anchorage, AK (US)

Correspondence Address: WILLIAM D. HARE, 66 WITHERSPOON STREET, STE. 1, PMB 317, PRINCETON, NJ, 08542-9944, US

(21) Appl. No.: 12/391,705

(22) Filed: Feb. 24, 2009

Related U.S. Application Data
(60) Provisional application No. 61/032,108, filed on Feb. 28, 2008.

(51) Int. Cl. A47B 96/06; F16M 13/00

(52) U.S. Cl. 248/121; 248/309.1; 248/306

(57) ABSTRACT

The invention generally relates to a case to hold a portable electronic device. The case may be a holder for a personal media player and includes a clip, a cradle, a swivel mechanism, and a connector mechanism. The clip has elastic properties. The cradle includes a pair of cradle bases and is configured to hold the personal media player. The swivel mechanism is connected to the cradle. The connector mechanism is positioned to retain the clip to the swivel mechanism and is configured to permit movement in at least two axes.

### TECHNICAL FIELD

The field of the invention generally relates to a case to hold a portable electronic device.

### BACKGROUND

For the last decade or more, portable digital devices, including cell phones, personal digital assistants, and portable media players have become increasingly popular. Even more recently, these items have become video-enabled. Now device owners can download and watch music videos, television shows, and even movies on these personal media players. In particular, devices like MP3 players and iPods have become mainstays for travelers, allowing them to occupy their time listening to music and watching videos while in transit.

Currently, when someone views or listens to a portable media player, they tend to hold the item in their hand. If the user is just listening to the device, they place it in their pocket, retrieving the item any time they need to access the device controls to change the music or other media item to which they are listening. If they wish to use the portable media player without holding it, they may place it on a flat surface or even arrange it at some angle by leaning it up against a separate object. When on a flat surface, the device user must look down at it to see what is on the screen, and when leaned up against another object, the device can easily slip when the user tries to press or interact with the device controls. In addition, if the user is in transit in a car, or on a bus, train, or plane, their traveling environment often experiences bumps that result in the item falling over or shifting from the desired viewing position.

Many device owners tend to purchase accessories for these devices to make them either look more attractive or to provide some additional functionality that is not inherent to the device on its own. One such accessory is a case for the device. Although several different cases are available for use with personal media players and other handheld electronic devices, the majority of these are decorative, being made of flexible material and designed for fashion purposes. Some, however, are made of harder, more impact-resistant materials, and are designed to protect the device should it be dropped or have undesirable force or pressure exerted on it by other means. Very few of these cases allow the device user to place the case on a surface in a freestanding orientation or attach the case to a separate surface. Although some of the existing cases allow the user to rotate the device up and down or right and left, not one of them allows the user to position the device screen along a variety of axes to achieve an optimal viewing angle.

There are a number of patents that disclose cases for portable electronic devices. U.S. D556,448 to Brandenburg, titled “Portable Digital Media Player Case,” discloses a case that covers a digital media player such as an iPod, iPhone, MP3 player. The case covers the player, and has a stand that folds out from the back so that it can stand on its own. It also has a small metal clip called a winder around which the earphone cord and buds may be wrapped. However, the design obscures much of the face of the item, which may not work for many of today's video-enabled digital media players.

U.S. D518,290 to Andre et al, titled “Handheld Device Housing,” discloses a case that houses the handheld device and provides a display viewing window and a window to access the device controls. The case is simply a decorative cover.

U.S. D472,373 to Hillman, titled “MP3 Player Case,” discloses an ornamental design for a case to house an MP3 player or other digital media player. The case is constructed of leather or other flexible, pliable material. The material creates a pouch into which one slides the player, then a flap comes up over the top of the device from the back and secures to the front of the case. The case has a narrow external clip in the back of the device designed to clip onto a belt or waistband.

U.S. Pat. No. 5,996,956 to Shawver, titled “Mounting Platform for an Electronic Device,” discloses a platform that holds an electronic device such as a personal digital assistant (PDA) and an accompanying stylus. The PDA is held to the mounting platform by two spring-loaded, movable tabs on the top of the platform, a pivoting tab on the same side as the stylus receptacle, and two fixed tabs on the bottom of the platform. The case has a u-shaped extension that pulls out from the back to serve as a stand. This mounting platform additionally appears to be specifically designed to work with a portable electronic device that uses a stylus.

U.S. Pat. No. 7,099,149 to Krieger et al, titled “Encasement for a Handheld Computer,” discloses an electronic device case with a cover having a specialized hinge assembly that allows the user to position the cover so that it functions as a stand for the device on a flat surface. With this encasement, the cover may be attached at the bottom or side of the device using a hinge assembly. When attached at the bottom, the basically flat, rectangular case cover, which covers the display of the device, may be opened and rotated completely to the back of the device, laying flat along the table or desk surface, and holding up the display at whatever angle the user desires. When mounted on the side, the cover can be rotated from the front to the back of the device, similar to the motion of opening a book. Once the cover is in back of the device, the device may lean on the case cover in the manner of a picture frame arm, with the short edge of the rectangular cover lying along the table or desk surface. Alternatively, the cover may be swiveled to place the long edge of the rectangular cover against the table or desk surface, enabling the device to achieve a more upward facing angle. The case is designed for using the device in a freestanding position on a flat surface.

U.S. Pat. No. 6,470,535 to Mayne et al, titled “Camming Belt Clip,” discloses a belt clip designed to hold a portable electronic device such as a cellular phone or portable media player. The clip rotates to clamp two wings together that hold the electronic device securely. The design holds a portable device in such a way as to display the interactive, front surface outwardly, but is specifically designed to clip onto a narrow belt or waistband and to allow quick release and securing of the device. The belt clip does not have a mechanism that allows the device user to see the device from any angle.

U.S. Pat. No. 6,752,299 to Shetler et al, titled “Rotational Holster for an Electronic Device,” discloses a holster designed primarily for use with medical electronic devices, although the holster could be used with other portable electronic devices. The holster is designed with a case for containing the device, along with a narrow clip for attachment onto the device user's belt or waistband. The device may be rotated up or down, and may also rotated like a dial to achieve a better viewing position for the device readout or for pressing controls from the user's belt. While the rotational position may be maintained, the tilting up or down loosens the clip, so is not a maintainable position.

U.S. Pat. No. 7,270,255 to Badillo et al, titled “Carrying Case with Adjustable Stand,” discloses a design for a case for use with any number of devices both electronic and non-electronic, including flashlights, GPS units, cell phones, and others. The case is very general, but includes a pouch for inserting the object, and then provides a malleable, but semi-rigid flap, or flaps, which can be bent to create a clip for clipping on a belt, over a rearview mirror, or other item. The flap may be extended out as a supporting arm to hold up the item in the case much like a freestanding picture frame is held on a flat surface.

U.S. Pat. No. 6,029,871 to Park titled “Cradle device having rotating hinge on pager,” discloses a case intended for use with a pager. The case has a clip for a belt and a rotating hinge on the upper portion that allows the user to tilt the pager up to read the incoming page without having to completely remove the pager from the case.

US Patent Publication 20070235492 to Sirichai et al, titled “Case for Portable Electronic Device,” discloses a case for a video-enabled electronic device. This case has two panels: an upper and a lower panel. One panel shows the controls through a window, and the other panel shows the readout or display through a window. The two panels are hinged in the back of the case and not secured permanently in the front. The top panel can be removed and folded to the back of the device, then may additionally be stabilized using a strap that extends from the top of top panel and is connectable to the bottom panel. In this way, the case can hold the device in a hands-free position on a flat surface such as a table. The case also has a loop or clip that may be used to suspend the device from some other object, but this clip does not provide the means to direct the display of the device in any particular direction.

US Patent Publication 2005/0072691 to Schlansky, titled “Holder for an Electronic Device,” discloses a case for an electronic device made from a single piece that includes a base and two arms. The arms are deflectable to hold the electronic device under the force created by the deflection of the arms. The holder may also be attached to a personal organizer or other surface, such as a desk or automobile dashboard through the use of some type of fastener. The invention does not focus on how the device might be attached; it just specifies either hook and loop, or other mechanical means of fastening.

U.S. Pat. No. 6,520,466 to Blanchard et al, titled “Personal Digital Assistant Attachment Mechanism,” discloses an attachment device for use with a personal digital assistant (PDA) which generally comprises a back surface, a base, and at least one securing arm. The securing arm or arms are resiliently deflectable to receive and retain the personal digital assistant under the force created in the deflection of the arms, and which allows the PDA to be selectively removed. The attachment device may include attachment apertures to secure the attachment device to a folio or other type of notebook, or to a surface such as a wall, an automobile visor, or an automobile dashboard. The attachment device may also be incorporated into a folio or similar device to provide protection to the personal digital assistant while allowing full access to, and operation of, the PDA. This device provides a base on which to temporarily attach a portable electronic device.

The inventor has determined that there is a need for a case for a portable media device that is different from those currently available. Those cases currently available appear to be missing one or more of a clip or stand for attaching to the case to anything like a tray table, for example, on an airplane; an articulating joint for positioning the device screen for viewing at any or a variety of angles; and a means, such as an extendable arm to position the device in an upright position on a flat surface. The inventor has determined from personal experience that for optimal use of a portable media device, these features provide advantages for the user.

### SUMMARY

In one general aspect a holder for a personal media player includes a clip, a cradle, a swivel mechanism, and a connector mechanism. The clip has elastic properties. The cradle includes a pair of cradle bases and s configured to hold the personal media player. The swivel mechanism is connected to the cradle. The connector mechanism is positioned to retain the clip to the swivel mechanism and is configured to permit movement in at least two axes.

Embodiments of the holder may include one or more of the following features. For example, the clip may include a first segment, a second segment, and a third segment, the segments being joined to form a generally U-shaped configuration, the first segment connected to the connector at a position proximate a first end of the first segment and to a first end of the second segment at a second end of the first segment, the third segment having a first end and a second end with the first end of the third segment being connected to the second segment at a second end of the second segment, the second end of the third segment and the first end of the first segment being arranged to define a slot bounded on two sides by the first and third segments and at an opposite end by the second segment.

The first segment, the second segment and the third segment may be made of an elastic material whereby the first segment and the third segment are movable relative to each other to vary the opening formed between the first segment and the third segment. The first end of the first segment may be closer to the second end of the third segment than is the second end of the first segment to the first end of the third segment.

The holder may further include a stand configured to be positioned within the clip. The stand may include a cylindrical portion that fits within the clip and an arm that extends from the cylindrical portion such that the cylindrical portion is configured to rotate within the clip. The arm may further include a pad mounted to an end of the arm such that the interaction between the pad and a surface on which the holder is placed causes the holder to remain upright.

Each cradle base may include a bottom surface, a front surface, a side surface and a back surface, the surfaces being configured to form a slot into which a personal media player may be inserted. Each bottom surface may further include a pad such that the interaction between the pad and a surface on which the holder is placed causes the holder to remain upright.

The swivel mechanism may include a pair of arms and a spring, the pair of arms connected to each other at first ends and each arm being connected to the cradle at a second end of each arm, the spring being mounted to the arms in a configuration having a tendency to pull the second ends of the arms together.

The connector may be a ball joint.

In another general aspect, a holder for a personal media player includes a clip, a cradle back and a connector mechanism. The clip may have elastic properties. The cradle back includes a pair of cradle hooks, the cradle hooks having an elastic property and being configured to retain the personal media player. The connector mechanism is positioned to retain the clip to the cradle back, the connector configured to permit movement in at least two axes.

The clip may include a first segment, a second segment, and a third segment, the segments being joined to form a generally U-shaped configuration, the first segment connected to the connector at a position proximate a first end of the first segment and to a first end of the second segment at a second end of the first segment, the third segment having a first end and a second end with the first end of the third segment being connected to the second segment at a second end of the second segment, the second end of the third segment and the first end of the first segment being arranged to define a slot bounded on two sides by the first and third segments and at an opposite end by the second segment.

The first segment, the second segment and the third segment may be made of an elastic material whereby the first segment and the third segment are movable relative to each other to vary the opening formed between the first segment and the third segment.

The first end of the first segment may be closer to the second end of the third segment than is the second end of the first segment to the first end of the third segment.

The holder may further include a stand configured to be positioned within the clip. The stand may include a cylindrical portion that fits within the clip and an arm that extends from the cylindrical portion such that the cylindrical portion is configured to rotate within the clip. The stand may further include a pad mounted to an end of the arm such that the interaction between the pad and a surface on which the holder is placed causes the holder to remain upright.

Each cradle hook may include a first segment, a second segment, and a third segment, the segments being joined to form a generally U-shaped configuration, the first segment connected to the cradle back at a position proximate a first end of the first segment and to a first end of the second segment at a second end of the first segment, the third segment having a first end and a second end with the first end of the third segment being connected to the second segment at a second end of the second segment, the second end of the third segment and the first end of the first segment being arranged to define a slot bounded on two sides by the first and third segments and at an opposite end by the second segment.

The first segment, the second segment and the third segment may be made of an elastic material whereby the first segment and the third segment are movable relative to each other to vary the opening formed between the first segment and the third segment.

The first end of the first segment may be closer to the second end of the third segment than is the second end of the first segment to the first end of the third segment.

Each second segment may further include a pad such that the interaction between the pad and a surface on which the holder is placed causes the holder to remain upright.

The connector may include a ball joint. The holder may further include a covering over the cradle back and cradle hooks.

The details of various embodiments of the invention are set forth in the accompanying drawings and the description below. Other features and advantages of the invention will be apparent from the description, the drawings, and the claims.

### DESCRIPTION OF THE DRAWINGS

FIG. 1 is an exploded view of the Case for a Portable Electronic Device.

FIG. 2 is a side view of an iPod Video and an iPod Nano.

FIG. 3 is a front view of the Case for a Portable Electronic Device.

FIG. 4 is a top view of the swivel arms of FIG. 3 showing the slotted design.

FIG. 5 is a side view of the Case for a Portable Electronic Device.

FIG. 6 is a front view of the spring of FIG. 5 that attaches to the swivel arms.

FIG. 7 is a rear view of the Case for a Portable Electronic Device.

FIG. 8 is a front view of a Case for a Portable Electronic Device containing a personal media player.

FIG. 9 is a front view of an iPod Video and an iPod Nano of FIG. 2.

FIG. 10 is a perspective view of a stabilizer stand for use with the Case for a Portable Electronic Device of FIG. 8.

FIG. 11 is a perspective view of the stabilizer stand of FIG. 10 being inserted in the spring clip.

FIG. 12 is a perspective view of a second embodiment of a Case for a Portable Electronic Device without a cover.

FIG. 13 is a perspective view of the second embodiment of the Case for a Portable Electronic Device of FIG. 12 with a cover.

FIG. 14 is a side view of the second embodiment of the Case for a Portable Electronic Device of FIG. 12 without a cover.

FIGS. 15 and 16 are perspective and front views, respectively of the spring clip having rounded edges.

FIG. 17 is a front view of a kickstand spring clip.

FIG. 18 is a side view of the second embodiment of a Case for a Portable Electronic Device of FIG. 12 without a cover and without the spring clip.

FIG. 19 is a side view of the kickstand spring clip of FIG. 17 with knurled and threaded knob and threaded hole in ball joint.

FIG. 20 is a side view of the second embodiment of the Case for a Portable Electronic Device of FIG. 12 with the kickstand spring clip of FIG. 17.

### DETAILED DESCRIPTION

The inventor recognized that although several cases have been designed for personal or portable media players and electronic devices, the majority of these cases are either decorative or are designed to encase the player to protect it from impact, such as a fall. A few cases are designed to allow the individual to place the object in a hands-free position on a flat surface, but none are designed to allow further directing of the display of the device. In addition, none appear to address the recent advances in technology that enable these devices to play video because they do not appear to have the capability for ensuring that the display window can be continuously viewed. As use of video-enabled and other types of media players becomes increasingly common, especially for those individuals who travel frequently, a device is needed that addresses these shortcomings.

A case is needed that not only securely holds a media player device, but that also allows the user to attach it to some object such as an airplane tray table so that it may be oriented in a nearly vertical position. Additionally, this same case must have the ability to be placed in a hands-free position on a flat surface such as a desk or table, and angled in such a way that the user can easily see the display. A case is also needed that allows the face of the media player to be further oriented, whether attached in a vertical position or set on a horizontal surface, to allow the user to achieve an optimal viewing perspective of the player display. Such a case must not damage the media player by scratching or other means, and must be designed to allow the user to access both the player controls and to see the display window.

The present Case for a Portable Electronic Device described herein addresses the issue of cases not being designed for personal media players in a hands-free manner and that do not allow the user to adjust the player for optimal viewing of the player's display window. The present invention provides a case that holds a personal media player securely, and enables the media player to be hung from an object such as an airplane tray table or placed on a flat surface with a stabilizing stand, and that can be further adjusted to optimize the viewing of and access to the display and controls. This item is an ideal case for a video-enabled media player, but is equally convenient and useful for any portable media player.

Thus, in one general aspect, the case for use with a portable media device includes two pieces that together form a cradle base, two rubber pads, two swivel arms, a spring, a ball joint, and a spring clip. The cradle base is formed by positioning one base piece on the left and the other on the right to form an incomplete slot into which a portable media player may be inserted. The left hand cradle base attaches to one swivel arm at the bottom end of the swivel arm using a rivet connecting means. The right hand cradle base attaches to the other swivel arm in a like manner. The two swivel arms are secured together at their top ends using a rivet connecting means to form an inverted “V” shape. The same rivet connecting means that secures the two swivel arms together further connects the swivel arms to the lower portion of the front side of a substantially u-shaped spring clip. Between the spring clip and the top portion of the swivel arms is a ball joint. And extending partway down the back of each swivel arm, with its apex at the point where the two swivel arms connect is a single v-shaped spring that provides tension to the swivel arms and the attached cradle base pieces. The rubber pads are adhered to the bottom side of the individual cradle base pieces, with one pad on each cradle base piece. The cradle base size and length of the swivel arms may vary to accommodate a number of styles and varieties of media players, with the spring-loaded swivel arms holding the media player securely in the cradle base pieces.

The invention additionally has a removable stabilizer stand. The stand shape is substantially a long, narrow triangle with a cylindrical-shaped “knob” at the top end and a rubber pad at the bottom end. The stand attaches to the back of the previously described cradle case with swivel arms and spring clip by inserting the cylindrical knob into the spring clip, where it is held by pressure exerted by the spring. The surface of the cylindrical knob is smooth enough to allow the stand to be rotated out or in enough to position the case at backward-leaning angles.

The cradle base will be made of a resilient, hard plastic material or other material that will not scratch or otherwise damage the media player. The swivel arms will be made of either a metal or hard plastic material that can withstand repeated movement. The clip will be made of a resilient metal material that can withstand repeated stretching. The stabilizer stand will be made of a hard plastic or other hard material. All materials may be coated with a substance that prevents them from scratching the media player.

The portable media player may be inserted into the slot created by the two cradle bases, with the spring-loaded swivel arms holding the player securely in place. The media player user may then hang the device over an airplay tray table or other similar object by hooking the spring clip over the object. The media player user can then manually position the screen at an optimal viewing angle by holding the screen and moving it into the desired position. The ball-joint mechanism has enough tension to hold the screen in place, but is loose enough to allow the user to manually position the screen.

In a freestanding position, the user may insert the cylindrical end of the stabilizer stand into the spring clip, then pull out the end of the stand with the rubber pad to an angle that allows optimal viewing. The user may additionally adjust the angle of the screen by grasping and positioning the screen using the ball-joint mechanism.

In a second embodiment of the present invention, a hard plastic back with two substantially j-shaped spring supports replaces the swivel arms and cradle base pieces as a container for the device. The two spring supports attached to the front of the plastic back located on the left and right sides. Each spring steel support is attached to the plastic back at two locations: at the top and at the bottom of the portion that lies flat along the plastic back. The plastic back is attached near its top to the spring clip, with a ball joint similarly inserted between the spring clip and the rear side of the plastic back. The case uses a rivet connecting means for attaching the spring supports to the plastic back and to the ball joint and spring clip. A padded spandex or other flexible, stretchable yet resilient material covers the hard plastic back and spring steel supports, with an area of the front of the cover cut out to create an opening large enough to view and use screen controls and the portable media device display area.

This embodiment of the device is used in a manner similar to the previously described embodiment. The media player user places the media player in the cradle formed by the plastic back, two spring supports, and the flexible, stretchable, and resilient fabric enclosure. Pressure exerted by the fabric enclosure holds the player in place. The spring clip is similarly used to attach the device firmly to an object. The ball-joint is similarly used to position the face of the device for optimal access and viewing. The stabilizer stand is similarly used to position the device on a flat surface such as a table or desk.

A detailed description of the two embodiments described above in generalities now follows.

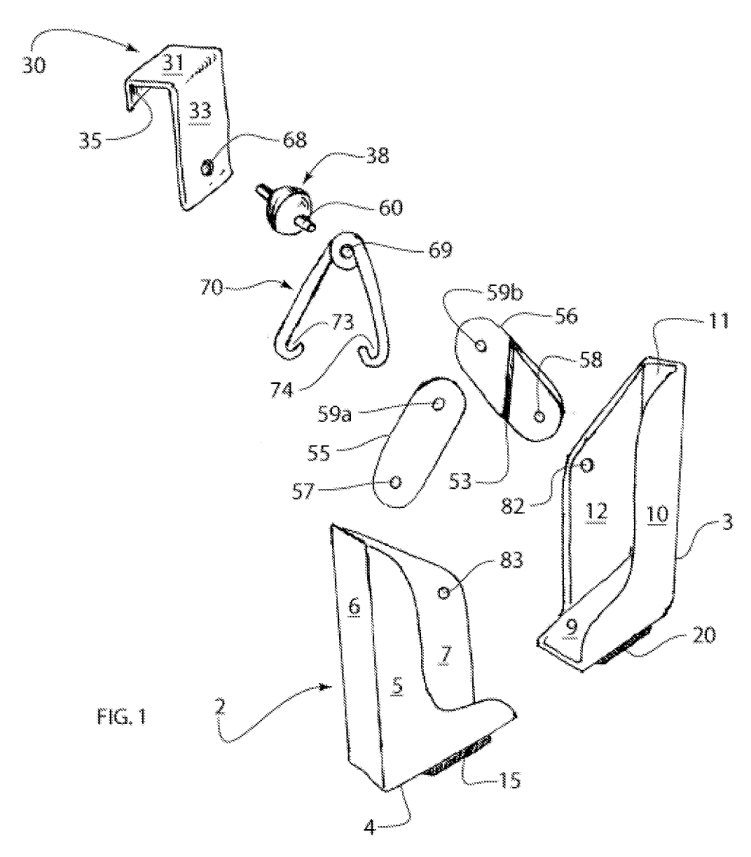

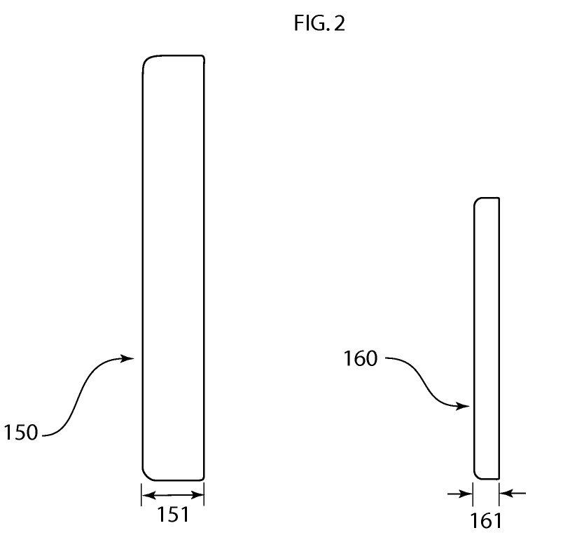

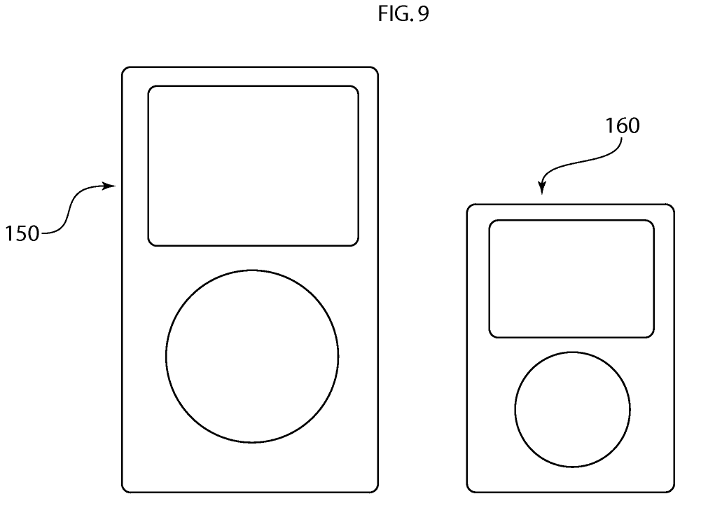

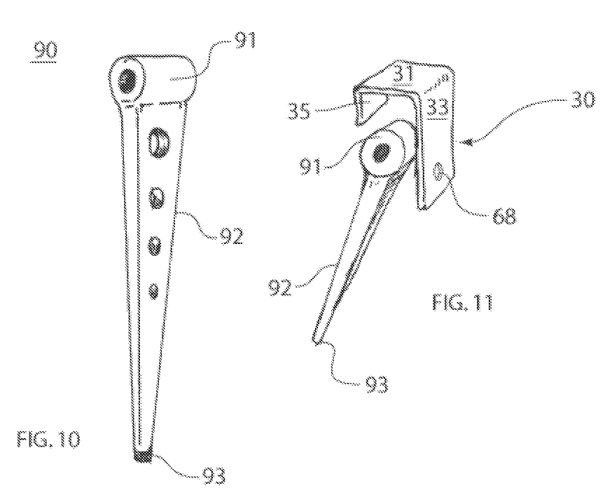

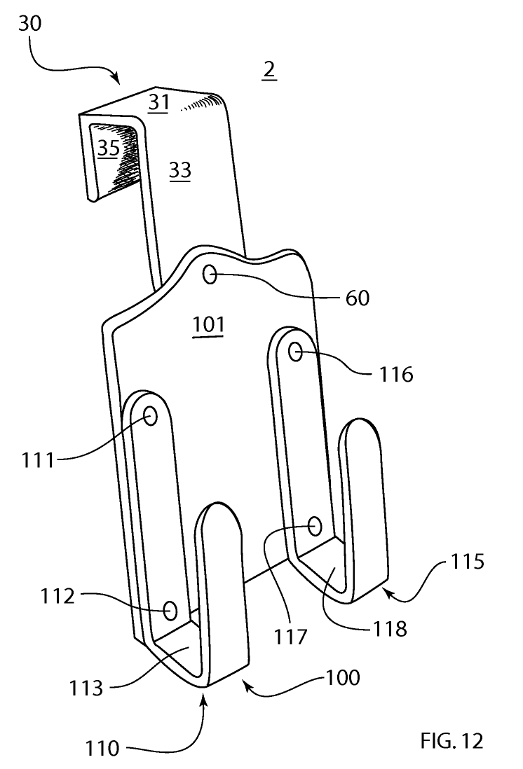

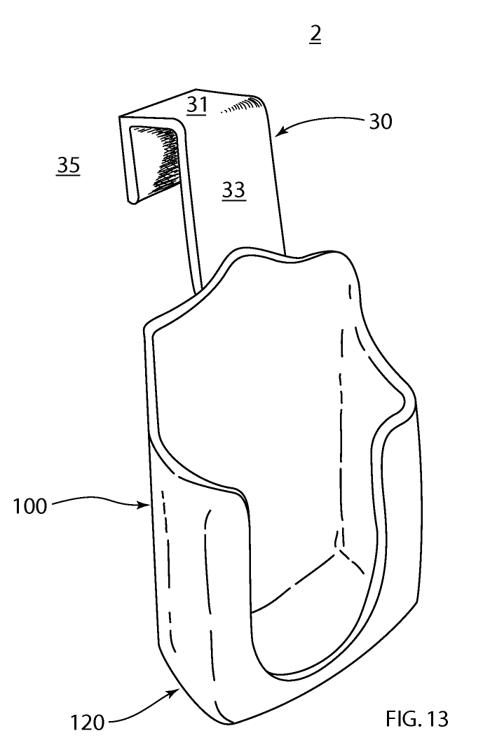

The inventor has developed a Case for a Portable Electronic Device as shown by the drawings in FIGS. 1 through 14. Each drawing has reference numbers that designate like or corresponding parts in each perspective view. The term “LH” refers to left hand, and the term “RH” refers to right hand. FIG. 1 and FIGS. 3 through 8 show a first embodiment 1 of the invention. FIGS. 10 and 11 show a stabilizer stand that may be used with the invention. FIGS. 12 through 14 show a second embodiment 2 of the invention. FIGS. 2 and 9 show the prior art iPod Video 150 and iPod Nano 160 portable media devices as examples of the type of device that would be housed by the present invention.

FIG. 1 shows an exploded perspective view of the first embodiment of the Case for a Portable Electronic Device 1 showing a LH cradle base 2 and a RH cradle base 3. The LH cradle base 2 has a bottom surface 4, a front surface 5, a side surface 6, and a back surface 7. The shape of the cradle base is irregular, but the four surfaces 4, 5, 6, 7 together form a slot into which the left side of a portable electronic device may be inserted. The thickness of the slot interior is roughly the thickness of a portable electronic device: for example, a thickness 151 of the iPod Video 150 or a thickness 161 of the iPod Nano 160 shown in FIG. 2. Likewise, the RH cradle base 3 has a bottom surface 9, a front surface 10, a side surface 11, and a back surface 12. The shape of the RH cradle base 2 mirrors the LH cradle base 3, with the four surfaces 9, 10, 11, 12 together forming a slot into which the right side of a portable electronic device may be inserted. The bottom surface 4 of the LH cradle base 2 has a rubber pad 15 adhered to and slightly protruding from its exterior surface. In like manner, the bottom surface 9 of the RH cradle base 3 has a rubber pad 20 adhered to and slightly protruding from its exterior surface.

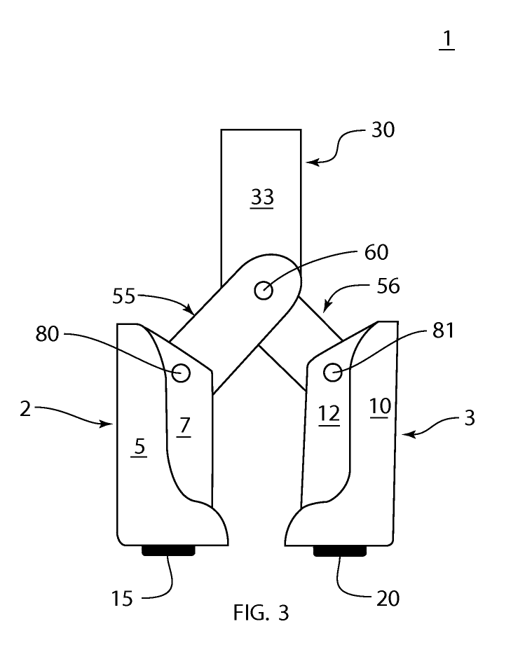

FIGS. 1 and 3 best show how the back surface 7 of the LH cradle base 2 has a rivet hole 83 located near the top right side that attaches the back surface 7 to a LH swivel arm 55 at a rivet hole 57 using a rivet connecting means 80. The back surface 12 of the RH cradle base 3 has a rivet hole 82 located near the top left that attaches it to a RH swivel arm 56 at a rivet hole 58 using a rivet connecting means 81.

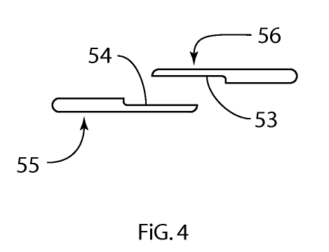

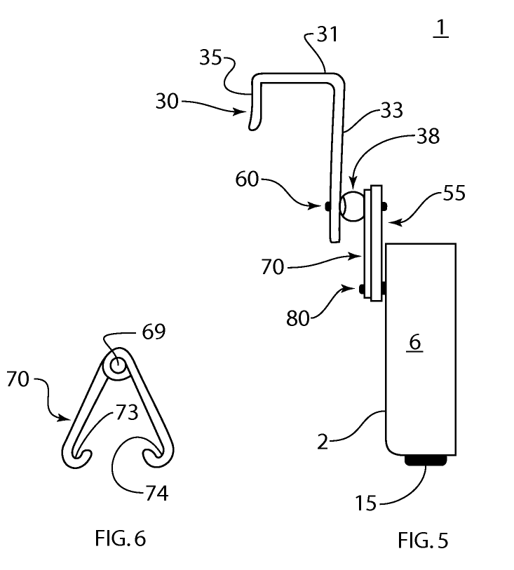

As best seen in FIG. 4, the LH swivel arm 55 has a slot 54 that lays flush against a slot 53 on the RH swivel arm 56. As seen in FIG. 1, near the top of the swivel arm 55 is a rivet hole 59a, and near the top of the swivel arm 56 is a rivet hole 59b. The rivet holes 59a and 59b align such that the LH swivel arm 55 connects to the RH swivel arm 56 using a rivet connecting means 60 as shown in FIGS. 3 and 5.

As best seen in FIGS. 1, 5, 6, and 7, on the back of the swivel arms 55, 56, which now form an inverted v shape, is attached a spring 70. The LH side of the spring 70 attaches at a rivet receptor 73 to the rear side of the LH swivel arm 55 by a rivet connecting means 80. The RH side of the spring 70 attaches to a rivet receptor 74 to the rear side of the RH swivel arm 56 by a rivet connecting means 81. The spring 70 attaches at an opening in the top 69 of the spring to the back of the swivel arms 55 and 56 by the rivet connecting means 60.

As best demonstrated by FIGS. 1 and 5, a ball joint 38 connects to the back of the spring 70 at the opening in the top 69 of the spring by the rivet connecting means 60. The spring clip 30 connects from the exterior of a front surface 33 at the rivet hole 68 to the back of the ball joint 38 also using the rivet connecting means 60.

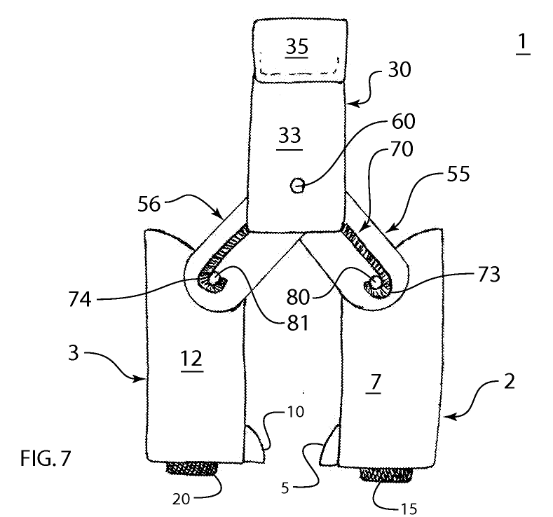

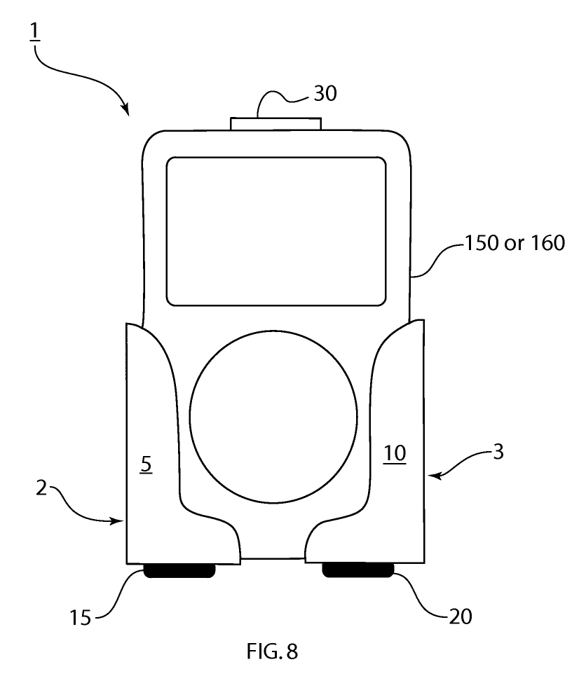

FIG. 7 shows the rear view of the entire case assembly 1 and particularly illustrates the rear view of the cradle bases 2 and 3, the swivel arms 55 and 56, and the spring clip 30. FIG. 8 shows the entire assembly of the first embodiment of the case 1 with a portable electronic device inserted in it such as the iPod Video 150 or iPod Nano 160 shown in FIGS. 2 and 9.

As best shown in FIGS. 3, 7, and 8, a portable electronic device such as the iPod Video 150 or iPod Nano 160 shown in FIGS. 2 and 9 is inserted into the case for portable electronic device by sliding the bottom of the electronic device into the cradle bases 2 and 3, which may be pulled outward to provide an opening wide enough to receive the portable electronic device. The cradle bases 2 and 3 maintain an inward facing pressure due to the spring 70 that is attached to the swivel arms 55 and 56. This inward facing pressure holds the portable electronic device securely in the cradle base pair 2, 3.

The case 1 is used in one way by clipping or hooking the interior of the back surface 35, top surface 31, and front surface 33 of the spring clip 30 over a tray table or other object with the front face of the portable electronic device facing outward. The device user then may further direct the angle of the display by tilting it at the angle that provides the optimal viewing perspective. The ball joint 38 enables tilting up and down as well as left and right, and also enables the viewer to rotate the device display should the viewer need to see the device with a landscape view or portrait view to use terms common to the printing industry.

The cradle base pieces 2, 3 can be constructed of a hard, high-impact plastic material that optionally can match the color of the individual media player. The swivel arms 55, 56 can be constructed of metal or some other resilient material, including a plastic material. The spring clip 30 can be constructed of a resilient, yet flexible material. The cradle base pieces 2, 3; swivel arms 55, 56; and spring clip 30 can each be coated, if necessary or desired, by a material that prevents them from scratching a portable electronic device. In addition, the width of the spring clip 30 can be such that the interior of the top surface 31 would measure the same as the thickness of an airplane tray table.

As shown in FIGS. 10 and 11, the invention additionally has a stabilizer stand 90, with a cylindrical head 91, an arm 92, and a rubber pad 93. The stabilizer stand 90 is used by inserting the cylindrical head 91 into the interior of the back surface 35, top surface 31, and front surface 33 of the spring clip 30.

A person with a portable electronic device may utilize the case 1 in another way with the stabilizer stand 90. The person grasps and rotates out or in the stand arm 92 to achieve a desirable viewing angle when the case 1 is placed on a flat surface such as a table or desk. The cylindrical head 91 slides within the interior of the back surface 35, top surface 31, and front surface 33 of the spring clip 30. The rubber pad 93 rests on the flat surface, as do the rubber pads 20 and 15 shown in FIGS. 1, 3, 5, 7, and 8, to hold the structure in a stable manner on the flat surface much like a picture frame with an extending support arm or a bicycle with a kickstand is supported on a flat surface. The device user may adjust the angle of the display as described earlier, relying on the ball joint 38 to enable a wide range of positioning angles.

The stabilizer stand 90 may be made of some hard plastic or metal, and the cylindrical head may be made of the same or different material in such a way that it slides smoothly within the spring clip 30, but also has enough friction to maintain its angle with the weight of the case 1 and a portable media device inserted.

A second embodiment 2 of the present invention is best seen in FIGS. 12 through 14. In this embodiment 2, a cradle assembly 100 that comprises a hard cradle back 101; a LH spring cradle hook 110 and a RH spring cradle hook 115; and a padded spandex or other material cover are used in place of the cradle base pair 2, 3; swivel arms 55, 56; and spring 70 assembly. The cradle back 101, which is substantially rectangular and the size of a portable electronic device, attaches to the substantially j-shaped LH spring cradle hook 110 with a rivet or other connecting means 121 located at the connecting point 111 and rivet or other connecting means 122 located at the connecting point 112 on the left side of the cradle back 101. The RH spring cradle hook 115, which is identical to the LH spring cradle hook 110, likewise connects to the cradle back 101 at a pair of points 116 and 117 with rivets or other connecting means. The cradle back 101 may be constructed of a high-impact plastic material. The cradle hooks 110, 115 may be constructed of a resilient yet flexible material. The bottom surfaces 113, 118 of the spring cradle hooks 110, 115 approximate the thickness of a portable electronic device; for example, the thickness 151 of the iPod Video 150 or the thickness 161 of the iPod Nano 160 shown in FIG. 2. The back surface of cradle assembly 100 connects at the rivet hole 102 to the ball joint 38 and the spring hook 30 in a similar manner to the first embodiment; that is, by using the connecting means rivet 60. A padded cradle enclosure 120 made of a durable, but flexible material such as spandex or neoprene stretches over the cradle assembly 100 to protect the portable electronic device from scratching or other damage. The cradle enclosure 120 has a cutout in front so that the display window and controls of a portable electronic device may be easily accessed and viewed. The cradle enclosure 120 may be made in a variety of decorative colors or patterns.

This second embodiment of the case is used in a similar manner as the first embodiment; that is, by inserting a portable electronic device into the pouch formed by the cradle assembly 100 and padded cradle enclosure 120. The device then functions just as the first embodiment functions: the device user may clip the device over a tray table using the spring clip 30 or may use the stabilizer stand 90 to position the device on a flat surface. The display is further adjusted for optimal viewing by manually tilting the face of the display using the ball joint 38 mechanism.

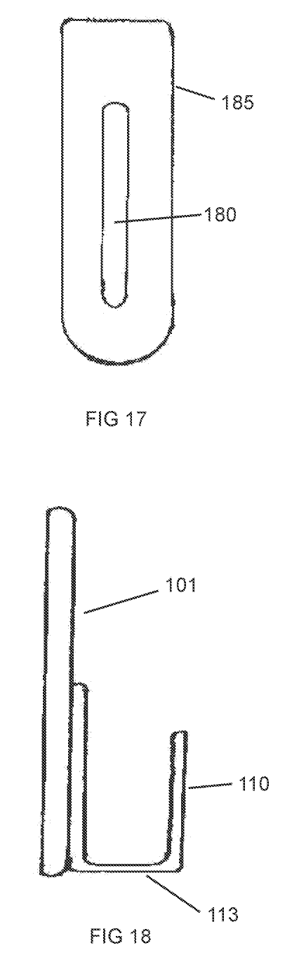

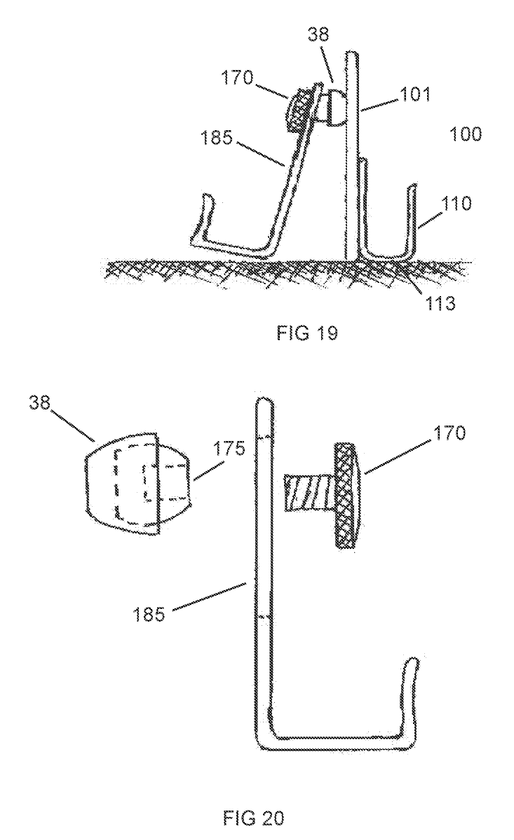

As best seen in FIGS. 17 through 20, the stabilizer stand 90 and spring clip 30 may be replaced by a kickstand spring clip 185 with a slot 180 that attaches to the ball joint 38 with a knurled, threaded knob 170 connecting means. The ball joint 38 in this case will have a threaded hole 175 to receive the knob 170. The ball joint 38 may be attached to the cradle back 101 by a rivet or some other connecting means. As seen in FIG. 19, the spring clip 185 attaches to the ball joint 38 by inserting the threaded end of the knob 170 through the slot 180 and into the threaded hole 175 of the ball joint 38.

A person with a portable electronic device inserted in the case 1 may utilize the kickstand spring clip 185 in two main ways. They may loosen the knob 170 and move the knob 170 up or down in the slot 180 of the kickstand spring clip 185. This sliding action moves the cradle back 101 up or down, allowing the device user to achieve an optimal vertical viewing level. Upon achieving the desired level, the user may then tighten the knob 170 in the threaded hole 175, preventing the knob 170 from sliding in the slot 180. As best shown in FIG. 20, the user may also utilize the kickstand spring clip 185 in place of the stabilizer stand 90 for use when placing the portable electronic device in the case 1 on a flat surface for viewing. The user swivels the kickstand spring clip 185 around approximately 180 degrees from the hanging position as shown in FIG. 12, and then uses the ball joint 38 to adjust the viewing angle as needed. The user may also slide the knob 170 in the slot 180 of the kickstand spring clip 185 to further adjust the viewing angle.

The kickstand spring clip 185 may optionally include a coating, cover or pads around the clip to provide a slip-resistant surface. For example, the slip-resistant surface may be, for example, a low-durometer rubber or plastic. Similarly, other portions of the case 1 that rest on a surface, also may have such a coating, cover or pads. In this manner, the case will sit on a surface, such as a table on an airplane, train, or car, with less likelihood of sliding on the surface as the airplane, train or car is moving.

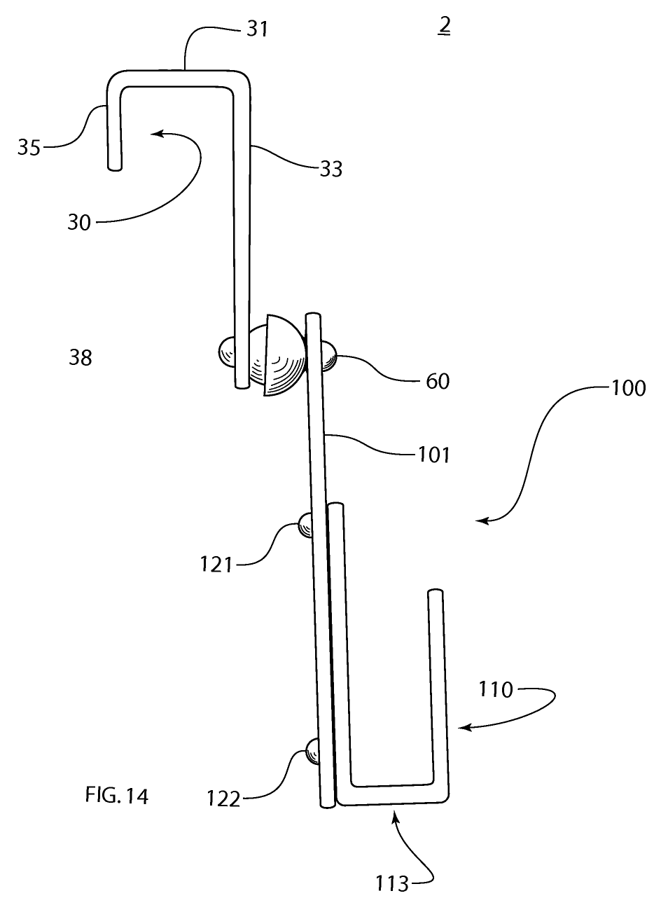

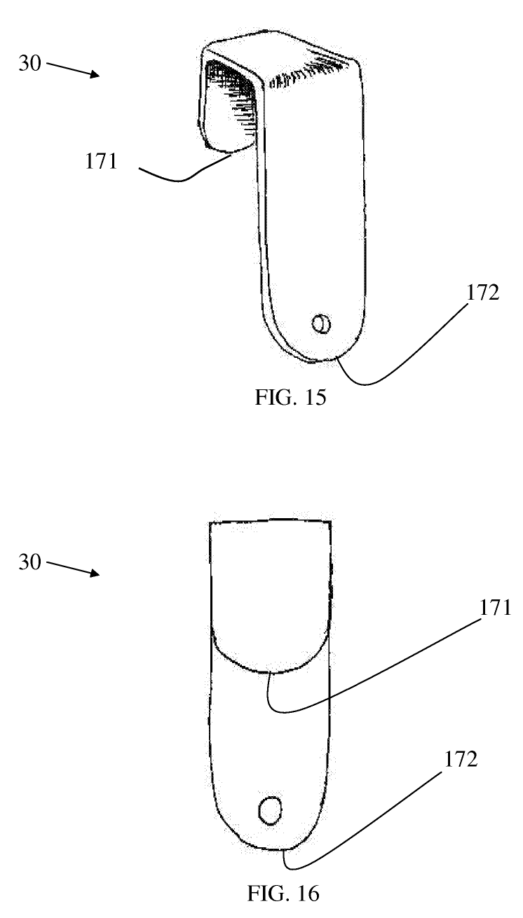

While several particular forms of the invention have been illustrated and described, it will be apparent that various modifications and combinations of the invention detailed in the text and drawings can be made without departing from the spirit and scope of the invention. For example, referring to FIGS. 15 and 16, the various components of the holder can be modified for esthetic or ergonomic considerations. FIGS. 15 and 16 illustrate the spring clip 30 being modified to have rounded corners 171 and 172 rather than the squared off ends disclosed, for example, in FIG. 1. This modification can enhance the esthetic and ergonomic features of the spring clip. Similarly, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited, except as by the appended claims.

What is claimed is:

1. A holder for a personal media player, the holder comprising:
a clip having elastic properties;
a cradle comprising a pair of cradle bases and being configured to hold the personal media player;
a swivel mechanism connected to the cradle; and
a connector mechanism positioned to retain the clip to the swivel mechanism, the connector configured to permit movement in at least two axes.

2. The holder of claim 1, wherein the clip comprises a first segment, a second segment, and a third segment, the segments being joined to form a generally U-shaped configuration, the first segment connected to the connector at a position proximate a first end of the first segment and to a first end of the second segment at a second end of the first segment, the third segment having a first end and a second end with the first end of the third segment being connected to the second segment at a second end of the second segment, the second end of the third segment and the first end of the first segment being arranged to define a slot bounded on two sides by the first and third segments and at an opposite end by the second segment.

3. The holder of claim 2, wherein the first segment, the second segment and the third segment are made of an elastic material whereby the first segment and the third segment are movable relative to each other to vary the opening formed between the first segment and the third segment.

4. The holder of claim 3, wherein the first end of the first segment is closer to the second end of the third segment than is the second end of the first segment to the first end of the third segment.

5. The holder of claim 1, further comprising a stand configured to be positioned within the clip.

6. The holder of claim 5, wherein the stand comprises a cylindrical portion that fits within the clip and an arm that extends from the cylindrical portion, wherein the cylindrical portion is configured to rotate within the clip.

7. The holder of claim 6, further comprising a pad mounted to an end of the arm, whereby the interaction between the pad and a surface on which the holder is placed causes the holder to remain upright.

8. The holder of claim 1, wherein each cradle base comprises a bottom surface, a front surface, a side surface and a back surface, the surfaces being configured to form a slot into which a personal media player may be inserted.

9. The holder of claim 8, wherein each bottom surface further comprises a pad, whereby the interaction between the pad and a surface on which the holder is placed causes the holder to remain upright.

10. The holder of claim 1, wherein the swivel mechanism comprises a pair of arms and a spring, the pair of arms connected to each other at first ends and each arm being connected to the cradle at a second end of each arm, the spring being mounted to the arms in a configuration having a tendency to pull the second ends of the arms together.

11. The holder of claim 1, wherein the connector comprises a ball joint.

12. A holder for a personal media player, the holder comprising:
a clip having elastic properties;
a cradle back comprising a pair of cradle hooks, the cradle hooks having an elastic property and being configured to retain the personal media player; and
a connector mechanism positioned to retain the clip to the cradle back, the connector configured to permit movement in at least two axes.

13. The holder of claim 12, wherein the clip comprises a first segment, a second segment, and a third segment, the segments being joined to form a generally U-shaped configuration, the first segment connected to the connector at a position proximate a first end of the first segment and to a first end of the second segment at a second end of the first segment, the third segment having a first end and a second end with the first end of the third segment being connected to the second segment at a second end of the second segment, the second end of the third segment and the first end of the first segment being arranged to define a slot bounded on two sides by the first and third segments and at an opposite end by the second segment.

14. The holder of claim 13, wherein the first segment, the second segment and the third segment are made of an elastic material whereby the first segment and the third segment are movable relative to each other to vary the opening formed between the first segment and the third segment.

15. The holder of claim 14, wherein the first end of the first segment is closer to the second end of the third segment than is the second end of the first segment to the first end of the third segment.

16. The holder of claim 12, further comprising a stand configured to be positioned within the clip.

17. The holder of claim 16, wherein the stand comprises a cylindrical portion that fits within the clip and an arm that extends from the cylindrical portion, wherein the cylindrical portion is configured to rotate within the clip.

18. The holder of claim 17, further comprising a pad mounted to an end of the arm, whereby the interaction between the pad and a surface on which the holder is placed causes the holder to remain upright.

19. The holder of claim 12, wherein each the cradle hook comprises a first segment, a second segment, and a third segment, the segments being joined to form a generally U-shaped configuration, the first segment connected to the cradle back at a position proximate a first end of the first segment and to a first end of the second segment at a second end of the first segment, the third segment having a first end and a second end with the first end of the third segment being connected to the second segment at a second end of the second segment, the second end of the third segment and the first end of the first segment being arranged to define a slot bounded on two sides by the first and third segments and at an opposite end by the second segment.

20. The holder of claim 19, wherein the first segment, the second segment and the third segment are made of an elastic material whereby the first segment and the third segment are movable relative to each other to vary the opening formed between the first segment and the third segment.

21. The holder of claim 14, wherein the first end of the first segment is closer to the second end of the third segment than is the second end of the first segment to the first end of the third segment.

22. The holder of claim 10, wherein each second segment further comprises a pad, whereby the interaction between the pad and a surface on which the holder is placed causes the holder to remain upright.

23. The holder of claim 12, wherein the connector comprises a ball joint.

24. The holder of claim 12, further comprising a covering over the cradle back and cradle hooks.
